(19) United States
(12) Patent Application Publication
(10) Pub. No.: US 2025/0045127 A1
(43) Pub. Date: Feb. 6, 2025

(54) METHOD OF DETECTING AND CORRECTING MULTI-PATH INTERFERENCE COMPONENT IN TOF CAMERA

(71) Applicants: SK hynix Inc., Icheon (KR); Korea Advanced Institute of Science and Technology, Daejeon (KR)

(72) Inventors: Joo Young KIM, Daejeon (KR); Dong Hyuk Kim, Daejeon (KR); Jae Young Kim, Daejeon (KR); Wok Tak Han, Daejeon (KR); Hae Rang Choi, Icheon (KR); Yong Kee Kwon, Icheon (KR); Jong Soon Won, Icheon (KR)

(21) Appl. No.: 18/362,763

(22) Filed: Jul. 31, 2023

(51) Int. Cl. G06F 9/52; G06F 9/48

(52) U.S. Cl. CPC G06F 9/52; G06F 9/4881

(57) ABSTRACT

A multilevel processing in memory (PIM) includes a processor in which an optimal operator installed at several layers of memory, an accelerator type circuit for processing an irregular operation, and a scheduler for processing an irregular operation have been installed. The multilevel processing in memory includes a memory module including at least one rank in which a computation operation and a data storage operation are performed in response to a control command from a memory controller. The memory module, the rank, a PIM command scheduler included in the rank, a bank group processing unit, and a bank group constitute a plurality of layers, respectively.

### BACKGROUND

### 1. Field

Exemplary embodiments relate to processing in memory (PIM), and particularly, to multilevel PIM capable of balancing the distribution of a workload, minimizing a memory bottleneck phenomenon, and improving operation time and efficiency using an architecture that is optimized for a data movement between operation cores.

### 2. Discussion of the Related Art

Data analysis or data analytics involves analyzing data using various methods and tools, such as statistics, machine learning, and data visualization, to convert the analysis results into valuable business information. Data analysis is inherently data-intensive, often involving the collection of vast amounts of data and repeatedly performing a simple operation on it. While the operations associated with the data analysis are simple, they can require large data transfers between an operation device and memory when dealing with substantial datasets.

Data analysis involves operations that can lead to a memory bottleneck phenomenon, including operations such as Select, Aggregate, Project, Join, and Sort. To address issues of delay time and power consumption, data analysis employs processing in memory (PIM), also known as intelligent memory.

However, even in PIM architectures with a variety of operation cores, there is a drawback: they may not efficiently handle imbalances in workloads arising from irregular operations.

### SUMMARY

The present disclosure proposes multilevel processing in memory (PIM) including a processor in which an optimal operator installed at several layers of memory, an accelerator type circuit for processing an irregular operation, and a scheduler for processing an irregular operation have been installed. The multilevel processing in memory includes a memory module including at least one rank in which an operation and a data storage operation are performed in response to a control command from a memory controller. The memory module, the rank, a PIM command scheduler included in the rank, a bank group processing unit, and a bank group constitute a plurality of layers, respectively.

### BRIEF DESCRIPTION OF THE DRAWINGS

FIG. 1 illustrates multilevel PIM according to an embodiment of the present disclosure.

FIG. 2 describes bandwidth gains and supported operations of hierarchical function blocks of the multilevel PIM according to an embodiment of the present disclosure.

FIG. 3 illustrates a rank buffer included in a rank according to an embodiment of the present disclosure.

FIG. 4 illustrates a PIM command scheduler included in a chip according to an embodiment of the present disclosure.

FIG. 5 illustrates a bank group processing unit included in each chip according to an embodiment of the present disclosure.

FIG. 6 illustrates a bank processing unit according to an embodiment of the present disclosure.

FIG. 7 describes a process of computing a query statement for data analysis in the multilevel PIM according to an embodiment of the present disclosure.

FIG. 8 illustrates CIMT architecture according to an embodiment of the present disclosure.

FIG. 9 illustrates an example of an operational flow of a Select operator.

FIG. 10 illustrates an example of an operational flow of a Project operator.

FIG. 11 illustrates an example of a format of a 64-bit PIM command.

FIG. 12 illustrates an example of data mapping.

### DETAILED DESCRIPTION

In order to sufficiently understand the present disclosure, operational advantages of the present disclosure, and an object achieved by carrying out the present disclosure, reference needs to be made to the accompanying drawings illustrating embodiments of the present disclosure and contents described with reference to the accompanying drawings.

Hereinafter, embodiments of the present disclosure are described in detail with reference to the accompanying drawings. The same reference numerals presented in the drawings refer to the same members.

First, function blocks that constitute multilevel processing in memory (PIM) that has been hierarchically implemented according to an embodiment of the present disclosure is described. Both connections between components of the multilevel PIM and operations of the components are described.

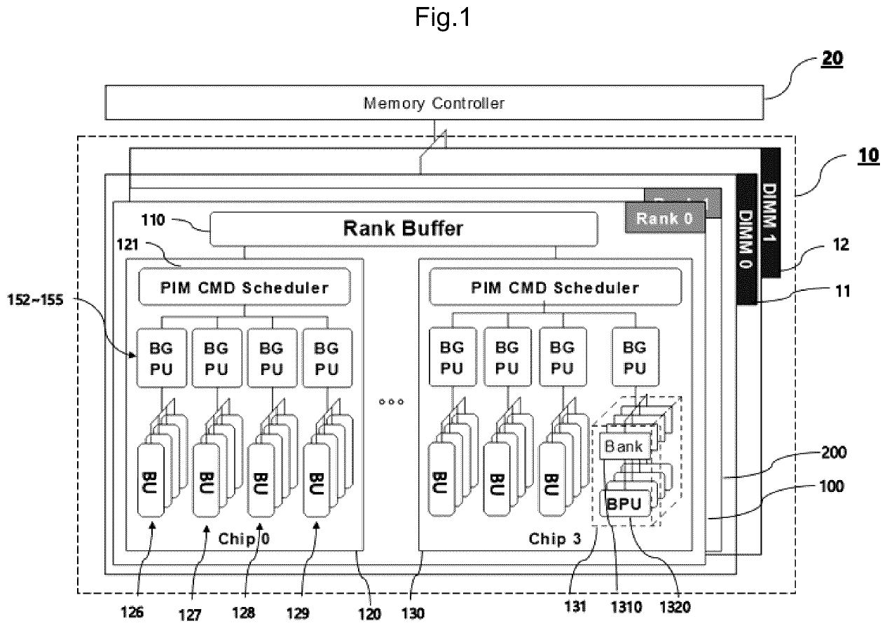

FIG. 1 illustrates multilevel PIM 10 according to an embodiment of the present disclosure.

Referring to FIG. 1, the multilevel PIM 10 may include one or more memory modules 11 and 12 each performing a computation operation and a data storage operation under the control of a memory controller 20. The memory modules 11 and 12 may each be a dual inline memory module (DIMM) including a plurality of ranks. Each rank includes a plurality of memory chips.

Hereinafter, components that constitute each of the memory modules 11 and 12 will be first described. Operational characteristics of each of the components will be described later along with a corresponding drawing.

Each of the memory modules 11 and 12 may include one or more ranks 100 and 200.

Each of the ranks 100 and 200 may include a rank buffer 110 and a plurality of chips 120 and 130. The rank buffer 110 may manage a data movement between the plurality of chips 120 and 130 within each rank.

Each of the plurality of chips 120 and 130 may include a PIM command scheduler (PIM CMD Scheduler) 121, a plurality of bank group processing units (BG PUs) 152 to 155 and a plurality of bank groups (BUs) 126 to 129. The PIM command scheduler 121 may individually manage a command that is necessary for an irregular operation. Each of the BG PUs 152 to 155 may manage computation or data processing that is performed within each bank group.

Each of the bank groups 126 to 129 and 131 may include a plurality of banks and a plurality of bank processing units (BPUs). For example, the bank group 131 may include a plurality of banks 1310 and a plurality of BPUs 1320. For the simplification of the drawing, the plurality of banks may be representatively assigned a reference numeral “1310,” and the plurality of BPUs is representatively assigned a reference numeral “1320.” Furthermore, each bank 1310 may include a memory cell array that stores binary information, and peripheral circuits, but detailed descriptions of the memory cell array and the peripheral circuits are well known and thus omitted herein.

Referring to FIG. 1, the multilevel PIM 10 may have hierarchical architecture of a DIMM-based memory system. It may be seen that the memory modules 11 and 12, the plurality of ranks 100 and 200 included in each of the memory modules 11 and 12, the rank buffer 110 and the plurality of chips 120 and 130 that are included in each rank, and the PIM command scheduler 121, the bank group processing units 152 to 155, and the bank groups 126 to 129 that are included in each chip sequentially form technical hierarchy (hereinafter referred to as “hierarchy”). In this case, the hierarchy can refer to a technical dependency or inclusion relation, where an operation of a specific lower component is controlled by another higher component.

For example, the memory controller 20 may be positioned at a higher layer than the memory modules 11 and 12, and the memory controller 20 may control operations of the memory modules 11 and 12. The ranks 100 and 200 may be disposed at the same layer in each of the memory modules 11 and 12. In the rank 100, the rank buffer 110 may be positioned at a higher layer than the plurality of chips 120 and 130. In each chip 120, the PIM command scheduler 121 may be positioned at a higher layer than the plurality of BG PUs 152 to 155, and the BG PUs 152 to 155 may be positioned at a higher layer than the plurality of bank groups 126 to 129.

Each of the plurality of chips 120 and 130 may have data pins for the transmission and reception of data. The number of data pins may be a multiple of two, denoted as N.

Each of the bank groups 126 to 129 may include multiple pairs of banks and BPUs. The pairs of banks and BPUs may be connected in parallel to the BG PUs 152 to 155 that is positioned at a higher layer. In this case, the expression “connected” may mean that the pairs of banks and BPUs are electrically connected to the BG PUs or the pairs of banks and BPUs can transmit and receive data to and from the BG PUs.

Hereinafter, while the structure and function of the multilevel PIM 10 are described in the context of supporting data analysis operations, they can be applied to any technology or industry that requires tasks involving extensive data computation.

An embodiment of the present disclosure proposes that the multilevel PIM 10 can optimize the delay in operation execution and processing speed caused by data transmission and reception. This optimization is achieved by installing optimal operators in several layers to support data analysis operations.

In an embodiment of the present disclosure, a regular operation, among various types of operations necessary for data analysis, may be performed at a bank level, which is the lowest layer. For example, the BPU 1320 installed in each of the bank groups 126 to 129 may process the regular operation.

An irregular operation, among the various types of operations necessary for the data analysis, may be processed by the BG PUs 152 to 155, which are positioned at a higher layer than the bank groups 126 to 129.

In this case, the regular operation may include Select, Aggregate, and Sort operations. The irregular operation may include Project and Join-merge operations.

The regular operation, which is frequently performed during the data analysis, may be performed at the bank level, which is the lowest level, because this allows for maximizing data parallelism by enabling a plurality of banks to distribute and execute the regular operation simultaneously.

In most cases, the irregular operation may require a data movement between banks included in a bank group rather than between a bank and a BPU. Accordingly, an embodiment of the present disclosure may propose that the irregular operation is performed at the bank group level, which is higher than the bank level in which the regular operation is performed.

In an embodiment of the present disclosure, in order to minimize an increase of power consumption and data processing delay according to data transmission, the data parallelism may have been considered for the regular operation, and efficiency of a data movement may have been considered for the irregular operation.

To ensure the efficient operation of such a hierarchical architecture, an embodiment of the present disclosure introduces the PIM command scheduler 121, which supports threading at the bank group level within the chip. In this case, a “thread” refers to a single task unit that is independently processed.

If an operation of the multilevel PIM 10 having the hierarchical architecture according to an embodiment of the present disclosure is controlled by concatenated instruction multiple threads (CIMTs), it may lead to reduced power consumption and minimized data processing delays associated with data transmission.

In particular, in an embodiment of the present disclosure, by enabling the BPU 1320 and the BG PUs 152 to 155 to handle threads independently, a plurality of threads can be processed in parallel.

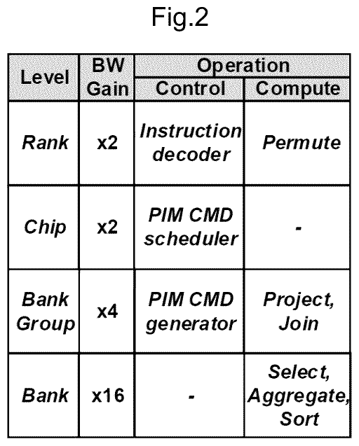

FIG. 2 describes bandwidth gains and supported operations of hierarchical function blocks of the multilevel PIM according to an embodiment of the present disclosure.

Referring to FIG. 2, it can be seen that the components of the multilevel PIM 10 shown in FIG. 1 may be divided into at least four layers. These layers, in descending order, are the rank, the chip, the bank group, and the bank.

In the rank, which is the highest layer among the above four layers, a bandwidth (BW) gain is X2 (by two), a controller (Control) for supported operations may be an instruction decoder, and an actual operation (Compute) may be performed in a Permute unit (Permute). In the chip, a BW gain is X2 (by two), a controller for a supported operation may be a PIM command scheduler (PIM CMD scheduler). In the bank group, a BW gain is X4 (by four), a controller for a supported operation may be a PIM command generator (PIM CMD generator), and an operation that is performed may include Project and Join-merge operations. In the bank, a BW gain may be X16 (by sixteen), and an operation that is performed may include Select, Aggregate, and Sort operations.

Hereinafter, structures and functions of a plurality of function blocks included in a memory device illustrated in FIG. 1 will be described.

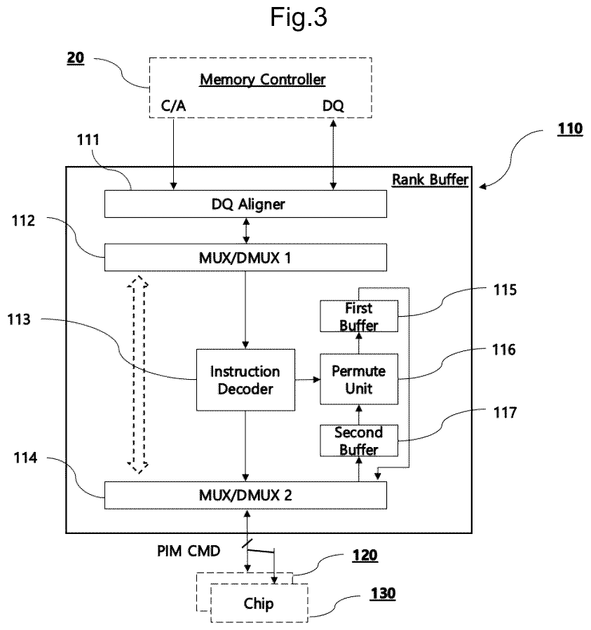

FIG. 3 illustrates the rank buffer included in the rank according to an embodiment of the present disclosure.

Referring to FIG. 3, the rank buffer 110 may include a DQ aligner 111, a first multiplexer/demultiplexer (MUX/DMUX 1) 112, a second multiplexer/demultiplexer (MUX/DMUX 2) 114, an instruction decoder 113, a first buffer 115, a second buffer 117, and a Permute unit 116. The rank buffer 110 illustrated in FIG. 3 may additionally include three function blocks, e.g., 113, 115 & 117, and 116, in addition to components of a conventional rank buffer.

When data are moved from one chip to another chip, the rank buffer 110 may receive, from the memory controller 20, a command to read the data from the one chip, and may wait for a column access strobe (CAS) latency, tCAS, in order to search for the data in the one chip. In this case, the CAS latency tCAS may be a common term that is included in the specifications of a DRAM device and that is widely used. The CAS latency tCAS refers to the time taken for requested data to be retrieved from a DRAM device and placed on a data bus after a column read command is input to the DRAM device.

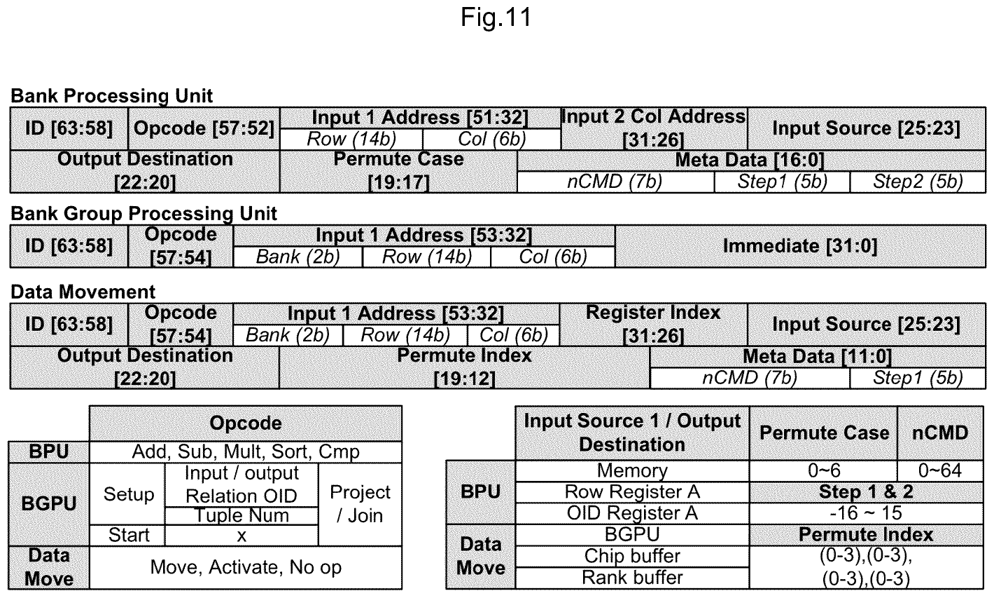

A signal including the command, which is received from the memory controller 20, may be transmitted to the rank buffer 110 through a command & address (C/A) pin. The rank buffer 110 and the memory controller 20 may exchange data through a data pin DQ. The rank buffer 110 may include the DQ aligner 111 to ensure reliable data transmission and reception. Ensuring the reliability of the data transmission and reception may include functions that synchronize data with a clock or minimize signal distortion. The first and second multiplexer/demultiplexers 112 and 114 in the rank buffer 110 may select some or all of data that are necessary at the proper timing. The instruction decoder 113 may transmit an operation code (opcode) to the Permute unit 116 in response to the command transmitted to the rank buffer 110. A detailed operation of the Permute unit 116 will be described later. A PIM command may specify the number of data read from an nCMD signal, which generates a sequence of read commands. In this context, the nCMD is used interchangeably with “7 bits (7b),” as illustrated in the table of FIG. 11. This indicates that “nCMD’ essentially denotes a command number. The rank buffer 110 may receive nCMD data in series and store the nCMD data in the buffer. Thereafter, the rank buffer 110 may receive a data write command intended for a bank in another chip. The data write command may include a Permute index, which re-designates the sequence of data within the rank buffer 110 and specifies it to be written back into a target bank.

In the drawing, a bidirectional arrow indicated by dotted lines indicates a data movement path of the conventional DRAM in which the three function blocks 113, 115 & 117, and 116 are not employed.

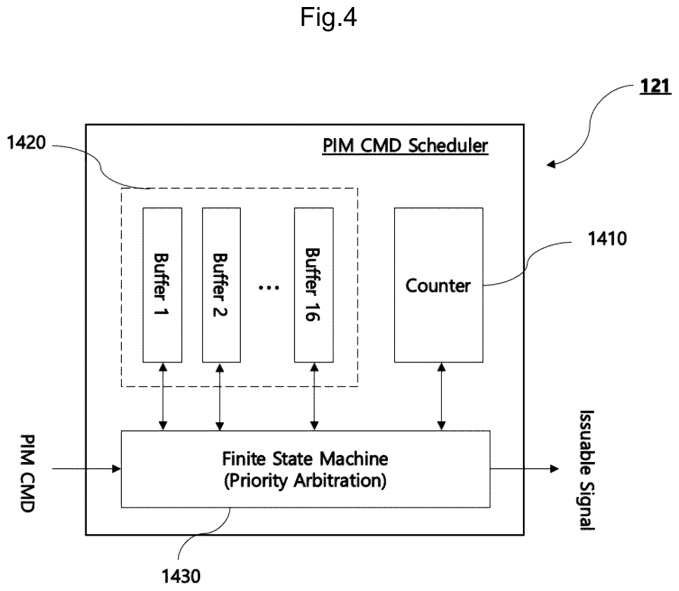

FIG. 4 illustrates the PIM command scheduler included in the chip according to an embodiment of the present disclosure.

Referring to FIG. 4, the PIM command scheduler 121 may include a counter 1410, a bank state register 1420 including a plurality of buffers “buffer 1” to “buffer 16,” and a finite state machine 1430 that arbitrates priority.

In the embodiment of the present disclosure, the multilevel PIM 10 includes the PIM command scheduler 121 that is at the chip level. The PIM command scheduler 121 supervises all bank group command queues by considering the row-to-row activation delay and inter-bank timing constraints, such as a 4-bank activation window. The PIM command scheduler 121 may control the data transfer into or out of the buffers based on a read operation or write operation, by managing the operations of each bank state register 1420 and each counter 1410, in conjunction with the inter-bank timing constraints. The control over the data transfer may encompass aspects like the amount of data, latency in data transmission and reception, and data counting. In general, such control may be determined based on the state of binary information within the finite state machine 1430 in response to a PIM command. The finite state machine 1430 may perform priority arbitration to determine which operation from several operations of the PIM command scheduler 121 gets prioritized and processed. In this context, the finite state machine 1430 may generate an issuable signal indicating which operation should be prioritized and processed. In general, the PIM command generated for data analytic operators may tend to follow a sequential memory access pattern, resulting in a minimal overhead for the PIM command scheduler 121.

In memory, a condition-oriented operator for data analysis may cause problems. The condition-oriented operator may lead to workload imbalances among processing entities due to non-deterministic execution flows, and thus may frequently require the movement of intermediate data both within a chip and outside the chip. Furthermore, the condition-oriented operator may require new command architecture that supports separate control of processing devices within the memory.

In order to solve the problems, an embodiment of the present disclosure may propose a BG PU described hereinafter.

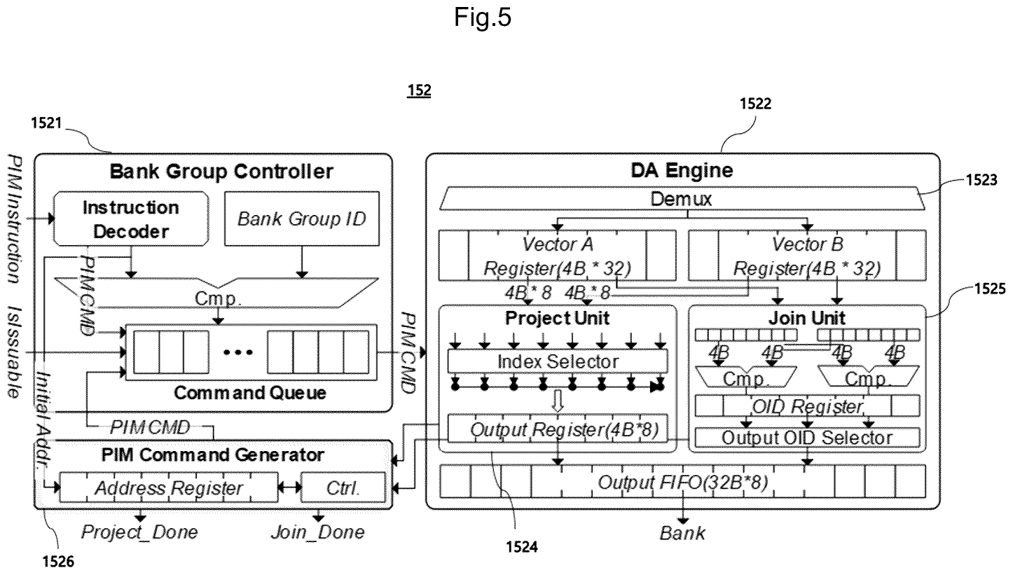

FIG. 5 illustrates the BG PU included in each chip according to an embodiment of the present disclosure.

Referring to FIG. 5, the BG PU 152 may include a bank group controller 1521, a DA engine 1522, and a PIM command generator 1526. The DA engine 1522 may include a demultiplexer (Demux) 1523, a Project unit 1524, and a Join unit 1525.

The PIM command generator 1526 may receive operation results of the Project unit 1524 and the Join unit 1525 from the DA engine 1522, and may generate a command PIM CMD at the bank group level. The command PIM CMD may include read and write commands for input and output attributes, which are necessary to prevent an off-chip command bottleneck phenomenon. When the BG PU 152 is disposed at the bank group level, the efficiency of the Project unit can be maximized by optimizing execution flow and minimizing workload balancing overhead.

The DA engine 1522 may include two vector registers Vector A and Vector B, the Project unit 1524, the Join unit 1525, and an output FIFO. The DA engine 1522 may enable the execution of a condition-oriented Project & Join operator by using the Project unit 1524 and the Join unit 1525. In the case of the Project operator (Project), an object identifier (hereinafter, referred to as an “OID”) and a bitmask may be stored in the vector register Vector A, and attributes thereof may be stored in the vector register Vector B. The Project unit 1524 may decode the OID or the bitmask. The OID or bitmask may indicate a tuple that is selected among projected characteristics. As a result, all operators except the Select operator may generate an OID set, whereas the Select operator may generate a simple bitmask in the BPU 1320.

Based on a pre-configured address and an initial value of the OID, the Project unit 1524 may first transmit the bitmask or the OID to the PIM command generator 1526, so that a memory read command for input attributes and a memory write command for output attributes can be generated. An index selector of the Project unit 1524 may select a projected tuple from among eight 4-byte (B) tuple data within a T_{CCDL} interval, based on the premise that the DRAM device has 16-bit DQ pins with a burst length, and may be designed to rate-match a peak bandwidth at the bank group level. In this context, T_{CCDL} may refer to a minimum burst interval or the shortest column-to-column command timing when accessing a bank within the same bank group. Subsequently selected output data may be stored in an output register. The index selector may select fewer than eight data depending on its selectivity. Once eight 4-byte data sets are fully populated in the output register, the eight 4-byte data sets may be dispatched to the output FIFO. Subsequently, the eight 4-byte data sets may be transmitted to the bank. To reduce read and write return standby times, the output FIFO may retain 256-byte data (32B*8 data) and then sequentially write it back into the bank.

During a Join-merge stage of a Join operator, two aligned attributes may be retrieved from the vector registers Vector A and Vector B that are included in the DA engine 1522. Two OID sets may be stored in the OID register of the Join unit 1525. The Join unit 1525 may receive and merge two attributes by sequentially comparing tuples that are executed by a Join controller (not illustrated). The Join controller may transmit an address of required attribute data to the PIM command generator 1526. The PIM command generator 1526 may generate memory read and write commands for a next input.

In order to rate-match the maximum bandwidth of a bank group, the Join unit 1525 may include two comparators (Cmp.) for processing two sets of tuples at once or a total of four 4-byte OIDs. The OID of output data that satisfies a Join-merge condition may be selected by an output OID selector of the Join unit 1525. Thereafter, the OID of two sets of tuples may be transmitted to the output FIFO. Like the Project operator, the output FIFO may retain an output data set and then sequentially write it back into the bank.

In the multilevel PIM, rather than verifying the Join-merge condition by transmitting the intermediate results of such condition-oriented query operators to a host CPU, the bank group controller 1521 may function as a CPU. This design may eliminate off-chip data movement for host-PIM communication.

The bank group controller 1521 may manage a PIM command within the bank group. The PIM command may be generated by the PIM command generator 1526. A PIM instruction may be decoded into a PIM command PIM CMD by the instruction decoder. PIM commands PIM CMD may be sequentially generated and then stored in a command queue. When executing the Project & Join operator, the PIM command generator 1526 may generate the PIM command PIM CMD based on an initial construction (Initial Addr.) that is received from the instruction decoder. When the PIM command PIM CMD is designated in the command queue, the bank group controller 1521 may receive an issuable signal from the PIM command scheduler 121 shown in FIG. 1 and transmit the PIM command PIM CMD to the DA engine 1522.

The PIM command generator 1526 may conditionally generate the PIM command PIM CMD that is determined according to a condition-oriented task. The DRAM device may operate as a timing-deterministic device, with control signals govern by strict timing rules. Accordingly, if the bank group controller 1521 determines the execution flow non-deterministically within the PIM, the memory controller of the host may struggle to identify the appropriate moment to send the next command. This issue can be easily addressed with a simple hand-shaking protocol between a CPU and a PIM device. If the device side does not assert an available signal, the host CPU may retain the next PIM instruction.

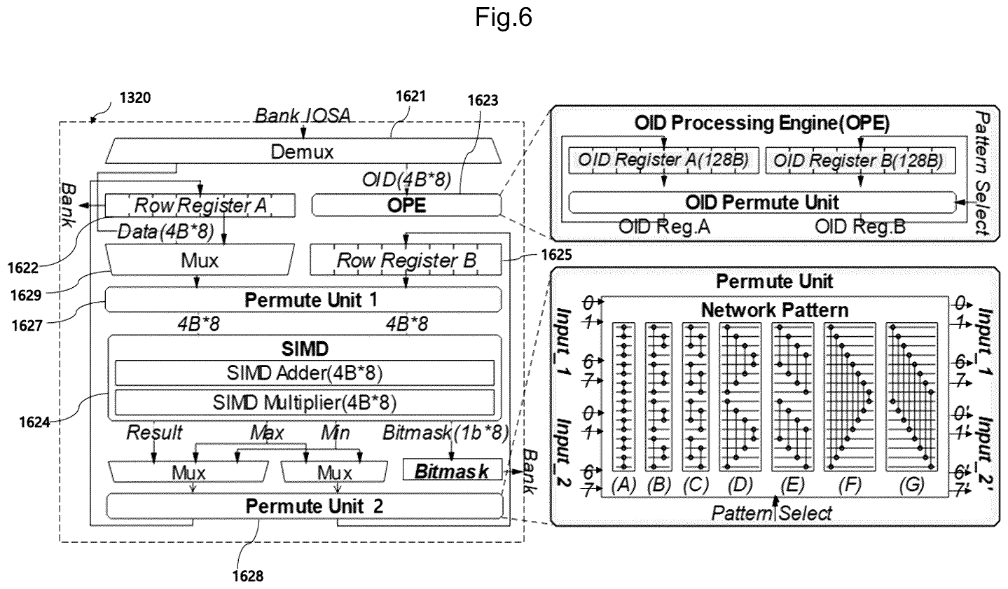

FIG. 6 illustrates the BPU according to an embodiment of the present disclosure.

Referring to FIG. 6, the BPU 1320 that is included in each chip and specified to process a regular operation may include a demultiplexer (Demux) 1621, two registers (Row Register A and Row Register B) 1622 and 1625, an OID processing engine (hereinafter, referred to as an “OPE”) 1623, an SIMD 1624, and two Permute units (Permute unit 1 and Permute unit 2) 1627 and 1628. In this case, the SIMD may be an abbreviation of single instruction multiple data.

Unlike in previous DRAM-based PIM architecture designed for matrix-vector multiplication having a simple data read and accumulation path, the multilevel PIM 10 according to the embodiment of the present disclosure can support a long data processing sequence for data analysis, including data Read, Align, Select, and Aggregate.

### Select and Aggregate Operations

The BPU 1320 may receive 32-byte (B) attribute data from an I/O sense amplifier (Bank IOSA) of the bank, demultiplexes the 32-B attribute data using the demultiplexer 1621 to prepare for data processing, and then store the demultiplexed 32-B attribute data in the row register A 1622 or the row register B 1625. The data stored in the row register A 1622 may be transmitted to the Permute unit 1 1627 via a multiplexer (Mux) 1629. The SIMD 1624 may include a set of eight 4-byte fixed point adders (SIMD Adder) and a set of eight 4-byte fixed point multipliers (SIMD Multiplier) that support the addition and multiplication and a minimum value and maximum value of eight 4-byte data, which comply with a bandwidth of a bank. The SIMD 1624 may output a bitmask, the maximum value (Max), the minimum value (Min), and operation results (Result). The maximum value, the minimum value, and the operation results may be multiplexed using multiplexers (Mux) based on an operation code (opcode) of an operator and then input to the Permute unit 2 1628.

For an Aggregate operator, the operation results (Result) may be accumulated in the row register A 1622. For an Select operator, one bit may be used as the bitmask indicating whether to select input tuple. Instead of using a 32-bit OID, that is, a 32-bit object identifier, as an output, using the bitmask can reduce a memory space for output data by 32 times. An output bitmask may be stored in a bitmask register (Bitmask) for selected data, and may be subsequently used by a project manager. The OPE 1623 may output, as an output, data indicative of the aforementioned several operation results and an address value corresponding to the data. Such an operation can reduce the time taken to extract an OID because the operation is performed simultaneously with a data computation operation that is performed by the SIMD 1624.

### Sort Operation

The BPU 1320 may accelerate a computing-intensive alignment operator rather than a memory-intensive operator. An embodiment of the present disclosure may propose using a bitonic merge alignment algorithm that consists of a special network known to operate well along with SIMD hardware and a parallel comparison between several stages. The complexity of the algorithm is O (nlog2n/k), wherein n is the total number of data and k is the number of data which may be computed at once. A bitonic merge alignment network may require 10 stages in order to align 16 data. Each of the stages may require a total of four commands, including input permutation, minimum permutation, a maximum value, and an output permutation command.

Furthermore, the number of commands may be doubled because a data address, that is, an OID, has to be aligned. In order to reduce an operation delay time in addition to the number of commands, the two Permute units 1627 and 1628 may be deployed before and behind the SIMD 1624. A sequence of data can be changed in a Sort operation by such deployment. The Permute units 1627 and 1628 may each receive sixteen 4-byte data. The sixteen 4-byte data may be multiplexed with a predefined network pattern for bitonic merge alignment as illustrated in FIG. 6.

In order to minimize area overhead, a circuit for the Permute unit may be optimized for only seven permutation patterns in a fully connected Permute network, and may support the alignment of all input patterns that are necessary for the bitonic merge alignment. Output data of the Permute unit 1627 may be transmitted to the SIMD 1624 for a comparison operation. The SIMD 1624 may simultaneously generate minimum (Min) data and maximum (Max) data in order to reduce two commands for minimum and maximum tasks.

Thereafter, sixteen output data may be transmitted to the Permute unit 1628 for output permutation. Furthermore, the BPU 1320 according to the embodiment of the present disclosure may support the OPE 1623 that performs the permutation of an address whose tag has been designated along with data results. If the OPE is used, an OID might not need to be separately multiplexed. The OID can be shuffled simultaneously with data by copying the results of the SIMD 1624 and applying the copied results to the OPE 1623.

It is not an easy task to process a data analysis workload consisting of regular & irregular operators by using PIM. In order to separately control an in-memory processing unit that computes the irregular operator, a conventional DRAM command protocol, which transmits one instruction at once by using a narrow command and address (C/A) pin, cannot provide a sufficient bandwidth to control the multilevel PIM according to the embodiment of the present disclosure. All bank modes can provide a great bandwidth so that processing devices within the PIM can simultaneously operate, but cannot efficiently process a complicated data analysis task because it has exceptionally low control granularity.

In order to solve the problem, the multilevel PIM 10 according to the embodiment of the present disclosure may have the capability to suggest the implementation of concatenated instruction multiple threads (CIMTs). This innovative approach enables the concurrent processing of multiple threads across various processing devices within a memory all while maintaining fine control granularity and avoiding the occurrence of a command bottleneck phenomenon.

The CIMTs are optimized to the physical layout of a main memory system including several DRAM chips in one rank. Unlike the existing command protocol in which different DRAM chips have to receive the same command, the CIMTs may be designed so that bank groups of different DRAM chips receive different commands. The multilevel PIM 10 may use 64-bit DQ pins rather than the C/A pin in order to provide a greater bandwidth when transmitting the CIMTs using a write command. Accordingly, the timing restriction condition for transmitting the CIMTs may be the same as that of the write command.

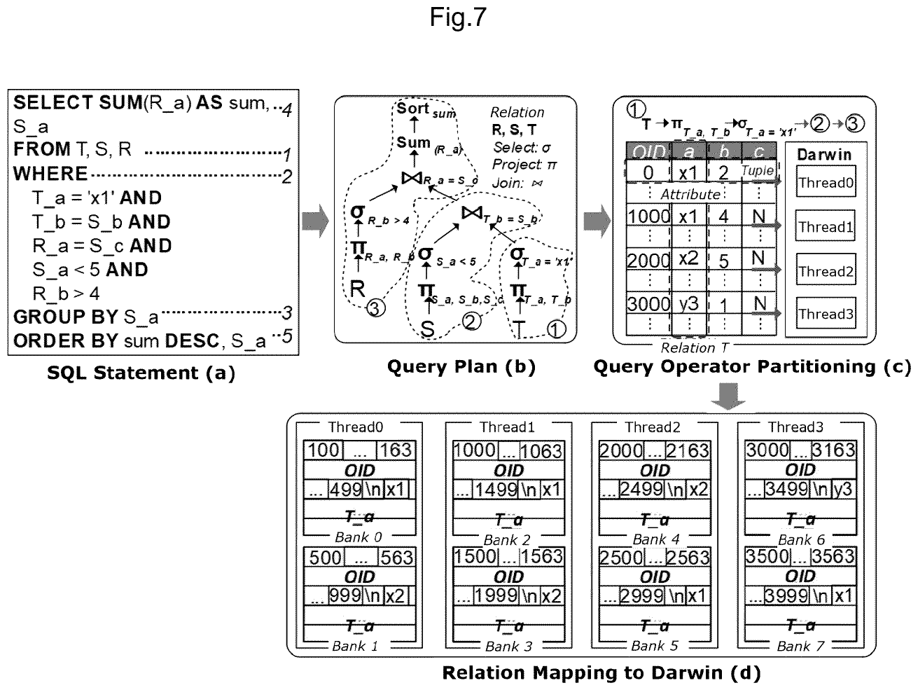

FIG. 7 describes a process of computing a query statement for data analysis in the multilevel PIM according to an embodiment of the present disclosure.

Referring to FIG. 7, when a structured query language (SQL) query statement (a) is compiled into a query plan (b), the SQL query statement (a) is partitioned into several operators (c), so that a flowchart (d) into which dependency between several types of operations has been incorporated is generated.

In this case, the SQL may mean an architectural data query language that is used to process data in a database system.

The operators may sequentially perform computations in the proposed PIM one by one. The operator may be divided into several threads. Each of the threads may divide required data and map the divided data to the PIM. Since a data analytic operation can perform data parallelism, only required attributes may be extracted from one table and allocated to the threads by uniformly distributing the attributes in a column direction. One thread may be mapped to one bank group of the PIM. The data may be sequentially stored in several banks within the bank group. Accordingly, when computing the data, a data access time can be minimized by allowing the data to be sequentially read and written.

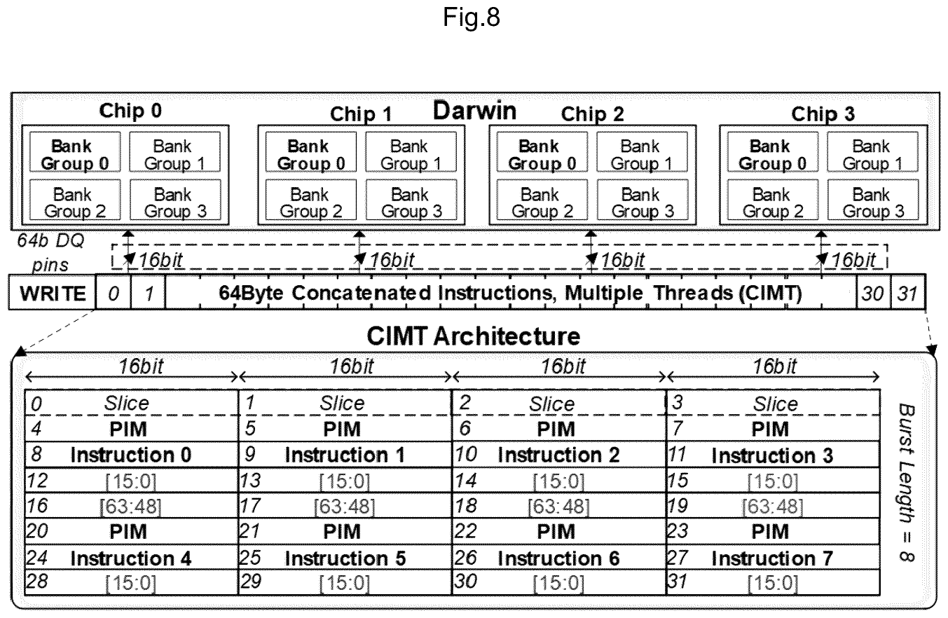

FIG. 8 illustrates CIMT architecture according to an embodiment of the present disclosure.

Referring to FIG. 8, each of four DRAM chips Chip 0 to Chip 3 has 16-bit DQ pins, and the four DRAM chips Chip 0 to Chip 3 form a rank along with 64-bit DQ pins for off-chip data transmission.

When the burst length of the CIMT architecture is 8 (Burst Length=8), data having a total data transaction size of 64 bits may be transmitted per write command. In order to make the sizes of data identical with each other, a CIMT instruction may include eight distinct 64-bit PIM instructions that are concatenated together. Each of the PIM instructions is segmented into four 16-bit slices. The 16-bit slices of the eight distinct 64-bit PIM instructions may be arranged in an interleaving manner to create eight 64-bit interleaving instructions. Thereafter, the 64-bit interleaving instructions may be streamed into the multilevel PIM according to the embodiment of the present disclosure through the 64-bit DQ pins, and may be formatted so that a corresponding instruction is transmitted to each chip. As a result, each chip may receive a full 64-bit instruction. 8 cycles may be taken to transmit all of the eight distinct 64-bit PIM instructions each having the burst length of 8.

Each PIM instruction may be decoded at the bank group level to generate a maximum of sixty-four sequential PIM commands, thereby reducing a burden to transmit the instructions through an off-chip bandwidth. The PIM command that has been generated from the PIM instruction may be a DRAM-readable command (e.g., activation, precharge, read, or write) that forms a pair along with a control signal from a processing device within the PIM. In order to increase the processing throughput of the BPU 1320, the BPUs 1320 can simultaneously operate because all the banks within the same bank group simultaneously receive the same PIM instruction. Accordingly, the CIMT architecture can individually control a maximum of different 512 BPUs 1320 at the same time.

The CIMT architecture illustrated in FIG. 8 may also be applied to another DRAM architecture.

The multilevel PIM according to the embodiment of the present disclosure can execute a data analytic operator by using the CIMT architecture which solves a command bottleneck phenomenon that occurs with a processing device within the multilevel PIM.

Hereinafter, an overall operation flow of the multilevel PIM according to the embodiment of the present disclosure, which is divided into data preparation, computation, and output stages, will be described.

In general, a regular operator, such as Select, Aggregate, or Sort, may have less fixed data in computing a vectorization operation. A computation flow of the regular operator may be the same in all threads when each of the threads has the same amount of input.

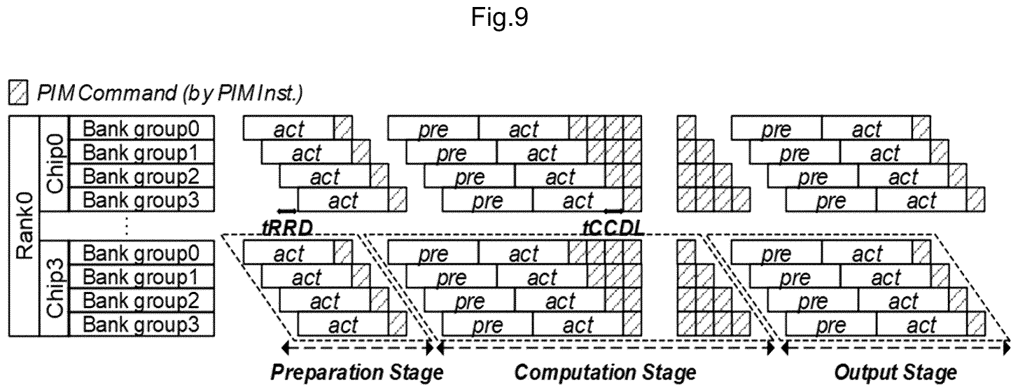

FIG. 9 illustrates an example of an operation flow of a Select operator.

Referring to FIG. 9, in a data preparation stage, a PIM instruction may be separately transmitted to each bank group. Required input data may be transmitted to the BPU 1320 of each bank. In order to reduce a data preparation standby time, the BPU 1320 may directly use data of one input operand from its own memory.

Scalar data of an SIMD operand may be transmitted only once in the preparation stage because attribute data of another operand may be directly transmitted from the memory in the computation stage. In the computation stage subsequent to the preparation stage, the BPU 1320 may execute the SIMDs in parallel. Only one PIM instruction may be required to compute a Select operator in a row of data because 64 sequential PIM commands can be generated from the one PIM instruction. The computation stage may continue until the registers are filled with generated outputs.

The BPU 1320, which includes the bitmask register having a 512-bit size, may compute a Select operator that generates a 512-bit output bitmask in one row, and then move to the output stage. Output data that are generated in the output stage may be stored in the memory again.

Since the size of the register of the BPU 1320 is limited, the output data might not be stored in the register during the entire operation. The Select operator may require four write commands in order to write 512-bit bitmask data per row in the memory again.

An irregular operator, such as Project or Join, may have a significantly complicated data flow between threads although the amount of input is the same, and thus cannot maintain the balance of a workload.

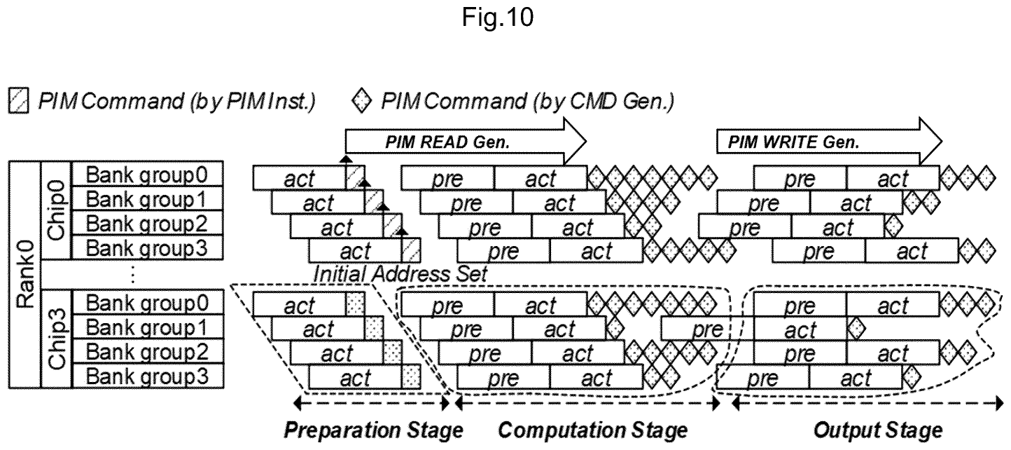

FIG. 10 illustrates an example of an operation flow of a Project operator.

Referring to FIG. 10, in a preparation stage, a tuple number and an initial OID may be initially set. Thereafter, 512-bit bitmask data that are generated by a previous Select operator may be transmitted to the BG PU 152. Thereafter, the BG PU 152 may receive a PIM instruction and generate a corresponding read command based on the bitmask data of input attributes. In a computation stage, the BG PUS 152 may receive different amounts of workloads because the BG PUS 152 have different bitmasks.

Each BG PU 152 may execute an individual command without a command bottleneck phenomenon because the BG PU 152 internally generates a command through the CIMT architecture. Furthermore, the computation of the BG PU 152 may be rate-matched with a maximum bandwidth of a bank group for a streaming execution flow. In an output stage, selected data may be stored in the output register of the BG PU 152. When the register is prepared, a write command may be generated in order to store output attributes in the register again.

In order to smoothly balance workloads, the BG PU 152 may generate a write command in a bank-interleaving manner and uniformly writes data in the memory of each bank. In order to use parallelism at the bank group level and also use a maximum bandwidth, the shortest standby time between write commands may be guaranteed. Such a process may be repeated until a corresponding task is terminated.

FIG. 11 illustrates an example of a format of a 64-bit PIM command.

Referring to FIG. 11, each of all types of commands may include an ID indicative of a thread and an operation code (Opcode) that represents a type of an operation. Each command may be classified to a command relating to a bank unit, a command relating to a bank group unit, or a command relating to a data movement depending on the Opcode.

In the command for the bank unit, three input sources may be present in one input of an SIMD operator, and the remaining one input of the SIMD operator may be fixed to the row register B. A Permute option may allow the Permute network of the bank unit to be controlled. A metadata option may allow consecutive PIM commands to be generated. However, the commands for a data movement may have a disadvantage in that a read write turn-around delay time may additionally occur because a read/write operation for actual data and a write operation for a PIM command may occur consecutively. In order to overcome the disadvantage, the metadata option may also be added to a PIM command for a data movement. Accordingly, a burden of the DQ pin can be reduced because several PIM commands can be generated within the PIM by only one PIM instruction.

A format (the bank unit) and construction of a BPU command are illustrated at the top portion of FIG. 11. While another operand is fixed to the row register B, three different types of input sources (e.g., the memory, the row register A, and the OID register A) may be provided to one input operand of the SIMD device. A Permute case may be used to control the Permute network of a bank processing unit. Metadata are used to generate sequential PIM commands by using nCMD, Step1, and Step2. nCMD may determine a maximum number of 64 sequential PIM commands that are generated by the PIM instruction. Step1 and Step2 may determine the offsets of column addresses for the first and second input sources, respectively. For example, when the column address, nCMD, Step1, and Step2 have 0, 4, 1, and 2, respectively, four sequential PIM commands each having the column address of an input operand on both sides thereof may be constructed in a state in which bank and row addresses have been fixed. That is, the sequential PIM commands (0, 0, 1, 2, 2, 4, 3, 6) are generated.

A command format (the bank group unit) and option of the BG PU are illustrated below the top portion of FIG. 11. An instruction may be for basically initializing the BG PU (the bank group unit). The instruction may be transmitted to the BG PU (the bank group unit) along with initial components (i.e., the input and output OID, the tuple number, and the memory address), so that a PIM command for a computing Project & Join operator can be generated, and may allocate an address for intermediate data. After the initial components are configured, a start command may start a Project and join the operator.

A data movement instruction (a data movement) may be constructed to enable data transmission between levels that are different from the level of the memory, i.e., between the bank unit, the bank group unit, the chip buffer, and the rank buffer. A data transmission space may be reduced because a PIM instruction for a data movement occupies the DQ pin. If more data transmission occurs, switching overhead for reading data through the DQ pin that transmits the PIM instruction will become worse.

In order to solve such a disadvantage, in an embodiment of the present disclosure, with respect to a data movement, nRD and the Step1 operation option may be activated, and the BG PU may generate sequential PIM commands, so that stress that is applied to the DQ pin is reduced by the PIM commands. Furthermore, a Permute index may determine a data shuffling sequence of the Permute unit in the rank buffer for a data movement between chips.

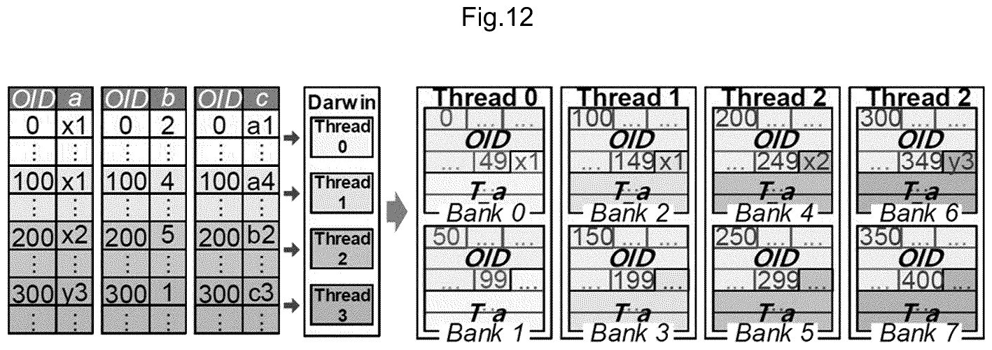

FIG. 12 illustrates an example of data mapping.

Referring to FIG. 12, the multilevel PIM according to the embodiment of the present disclosure uses the data parallelism and the bandwidth of DRAM to the maximum by adopting a storage model of a column-oriented database management system (DBMS).

In the column-oriented DBMS, attributes may be separately stored as an arrangement structure in order to accelerate an analytic query operator that performs a vector operation for each element of the attributes. Furthermore, column-oriented mapping may result in sequential memory access by which Darwin can use a minimum memory access delay time. Furthermore, relation division may be adopted in order to efficiently process an analytic query. FIG. 12 illustrates an example of a data mapping layout, considering a dual in-line memory module (DIMM) comprising four chips and one bank group containing two banks per bank group. Four different threads may be generated because one bank group corresponds to one thread. For a maximum utilization rate, in order to balance workloads between several threads, attributes and an OID column are equally divided by 4 that is a total number of threads, and each partition of the attributes is then mapped to a corresponding thread query operator. As a result, the same amount of computation can be executed.

The aforementioned present disclosure may be implemented in a medium on which a program has been recorded as a computer-readable code. The computer-readable medium may include all types of recording media in which data readable by a computer system is stored. Examples of the computer-readable medium include a hard disk drive (HDD), a solid state disk (SDD), a silicon disk drive (SDD), ROM, RAM, CD-ROM, a magnetic tape, a floppy disk, and an optical data storage device.

The technical spirit of the present disclosure has been described along with the accompanying drawings, but this exemplarily describes preferred embodiments of the present disclosure and is not intended to limit the present disclosure. Furthermore, it is evident that any person having ordinary knowledge in the field to which the present disclosure pertains may modify and imitate the present disclosure without departing from the category of the technical spirit of the present disclosure.

What is claimed is:

1. A multilevel processing in memory (PIM) comprising:
a memory module comprising at least one rank in which a computation operation and a data storage operation are performed in response to a control command from a memory controller,
wherein the rank comprises a plurality of chips and a rank buffer,
wherein the rank buffer manages a data movement between the plurality of chips in response to the control command,
wherein each of the plurality of chips comprises a PIM command scheduler, a plurality of bank group processing units, and a plurality of bank groups,
the PIM command scheduler individually manages a command necessary for computation,
a bank group processing unit performs an irregular operation, and
a bank processing unit included in a bank group performs a regular operation.

2. The multilevel PIM of claim 1, wherein the regular operations are performed in parallel in a plurality of banks included in the bank group.

3. The multilevel PIM of claim 1, wherein:
the regular operation comprises at least one of Select, Aggregate, or Sort, and
the irregular operation comprises at least one of Project or Join-merge.

4. The multilevel PIM of claim 1, wherein the rank buffer reads data stored in a bank of a first chip, among the plurality of chips, in response to a data read command received from the memory controller, stores the data, and transmits the data to a second chip in response to a write command received from the memory controller.

5. The multilevel PIM of claim 1, wherein the PIM command scheduler supervises a command queue of a plurality of banks included in a bank group installed in the chip in which the PIM command scheduler is installed.

6. The multilevel PIM of claim 1, wherein the bank group processing unit comprises:
a DA engine configured to perform Project and Join-merge operations; and
a bank group controller configured to receive results of the Project and Join-merge operations and to generate a command at a bank group level.

7. The multilevel PIM of claim 6, wherein the bank group processing unit further comprises a PIM command generator.

8. The multilevel PIM of claim 1, wherein the bank processing unit comprises an adder and a multiplier that are used to process the regular operation.

9. The multilevel PIM of claim 8, wherein the bank processing unit further comprises an object identifier (OID) processing engine configured to perform permutation on result data of the regular operation and an address to which a tag has been designated.

10. The multilevel PIM of claim 1, wherein the chip transmits and receives an instruction of the PIM command scheduler through a plurality of data pins.

11. The multilevel PIM of claim 10, wherein the instruction is composed of instruction segments that are arranged in an interleaving manner.

12. The multilevel PIM of claim 11, wherein a transmission cycle of the arrangement of the commands is determined by a burst length.

13. The multilevel PIM of claim 10, wherein the instruction comprises any one of activation, precharge, read, and write operations for the chip.
